(19) United States
(12) Patent Application Publication
(10) Pub. No.: US 2016/0379735 A1
(43) Pub. Date: Dec. 29, 2016

(54) ELECTRIC LINE AND METHOD OF PRODUCING THE SAME

(71) Applicant: LEONI KABEL HOLDING GMBH, Nuernberg (DE)

(72) Inventor: ERWIN KOEPPENDOERFER, SCHWABACH (DE)

(21) Appl. No.: 15/191,798

(22) Filed: Jun. 24, 2016

(30) Foreign Application Priority Data
Jun. 24, 2015 (DE) 102015211763.4

(51) Int. Cl. H01B 7/18; H01B 11/02; H01B 13/14; H01B 7/02

(52) U.S. Cl. CPC H01B 7/18; H01B 7/0275; H01B 11/02; H01B 13/14

(57) ABSTRACT

An electrical cable, in particular a signal cable, has an electrical conductor core and an insulating sheath that encompasses the electrical conductor core. The insulating sheath, which is an extruded sheath, has a core sheath region and at least one strain relief strip that extends in the longitudinal direction of the electrical conductor core and is embodied from a fiber composite material. The core sheath region and the at least one strain relief strip are applied to the conductor core in particular by a co-extrusion process.

The invention relates to an electrical cable, in particular a signal cable, having an electrical conductor core and an extruded insulating sheath that directly encompasses said conductor core, and a method for producing such an electrical cable. A cable of this type is disclosed by way of example in EP2 299 453 B1.

The number of weight-reduced electrical cables and cables that are currently being used in the automotive industry has increased in order to render it possible to reduce fuel consumption by means of the resulting reduction in weight. This relates both to the so-called supply lines, in other words the electrical connections that are used to supply the electric consumers, and also the so-called signal cables or data transmission cables, wherein their number has recently considerably increased in a typical on-board electrical system of a motor vehicle. This is also the reason why above all the further development of weight-reduced signal cables is currently the target.

Thus, an electrical signal cable is described in EP 2 299 453 B1 that is held by the applicant and in which the nominal cross-section of the conductor is reduced and in fact is reduced to the extent that the nominal cross-section of the conductor in the case of a predetermined desired current strength is now tailored to suit the dimensions required for the electrical conductivity. In other words, therefore, that the nominal cross-section of the conductor in the case of these signal cables is predetermined solely in dependence upon the electrical requirement and is tailored to suit this requirement. However, as a result of reducing the nominal cross-section of the conductor, the mechanical characteristics of the signal cables change, in other words also the load limits and thus the loadability of such signal cables change. In order to balance this out or compensate for it, the classic insulating material of such a signal cable that has a reduced nominal cross-section of the conductor is replaced by an insulating sheath embodied from a fiber-reinforced composite material that is designed in such a manner that this absorbs for example an essential portion of a tensile load that occurs so that the signal cable is designed in turn for a predetermined maximum tensile load.

Furthermore, it is known by way of example from EP 1 887 396 B1 and also from U.S. Pat. No. 5,764,835 A to in-lay strain relief strips or also a strain relief mesh into the insulating sheath in order to increase the tensile strength.

It follows from this that the object of the invention is to provide an advantageous electrical cable and also a method for producing a corresponding electrical cable.

This object is achieved in accordance with the invention by means of an ii electrical cable having the features of claim 1 and also by means of a method having the features of claim 14. Preferred further developments are disclosed in the related claims. The advantages that are achieved with regard to the electrical cable and the preferred embodiments can also be transferred in an expedient manner to the method and conversely.

A corresponding electrical cable or short cable is routed in particular as a signal cable and comprises an electrical conductor core and also an insulating sheath that encompasses said conductor core. The insulating sheath is applied directly on the conductor core, in other words without providing an intermediate layer of another sheath-shaped casing. As an alternative, the insulating sheath can also be applied under an intermediate layer of a protective coating. The insulating sheath comprises a core sheath region and also at least one strain relief strip that extends in the longitudinal direction of the electrical conductor core and is embodied from a fiber-reinforced material. The insulating sheath is embodied in particular as an outer sheath, in other words the cable does not have any other sheath that encompasses the conductor core in a concentric manner. Multiple cables of this type can be grouped together to form a set of cables.

It is preferred that the core sheath region already encompasses the conductor core completely in the peripheral direction and can therefore also be described as an inner sheath or as a base sheath. The at least one strain relief strip is applied to an outer region of this core sheath region and in particular is embedded in said outer region so that the core sheath region and the at least one strain relief strip form a smooth, common, in particular circular outer contour.

In contrast to the solution that is mentioned in the introduction and is disclosed in EP 2 299 453 B1 held by the applicant, it is not the entire insulating sheath that is produced from a fiber composite material but rather ii only one or preferably multiple strip-shaped part regions are produced from a fiber composite material. These strip-shaped regions are sufficient in order for the desired strain relief to be able to absorb the forces that occur. A tensile load that acts on the insulating sheath is preferably absorbed to a great extent, in other words more than 50% and in particular more than 75%, by the at least one strain relief strip.

Furthermore, the insulating sheath assumes a region of 20 to 80% and in particular more than 40% of the predetermined entire tensile load, in other words it is designed to absorb a comparatively large portion of the predetermined tensile load. It is preferred that the insulating sheath assumes a greater portion than the electrical conductor core. The remaining residual tensile load is absorbed by the electrical conductor core itself. The predetermined tensile load amounts by way of example to up to 150 N and in particular for instance only 50-100 N, in other words the cable must be able to resist a tensile force of a maximum 150 N or maximum 50-100 N. This means that the cable must not experience any mechanical damage under such a tensile load—with the corresponding safety tolerances. The cable therefore deforms in an essentially elastic manner; only a small amount of plastic deformation is allowed. The insulating sheath demonstrates this high degree of mechanical tensile strength even in particular in the relevant expansion range of less than 10% expansion.

Furthermore, this embodiment simultaneously maintains a high degree of bending flexibility. Tests have shown that in the case of a sheath that is embodied entirely from a fiber composite material, the electrical cable is too rigid for the frequently required small bending radii and the alternating stresses—in particular for the region that is of most interest here as (low cost) data cable especially in the automotive industry.

In contrast to the strain relief strip, it is preferred that the core sheath region does not contain any purposefully embedded fibers and is produced from a material as is used for a conventional insulating sheath, in other words for example from a PVC material.

Furthermore, it is of particular importance with respect to a simple as possible production process that the entire insulating sheath, comprising a core sheath region and the at least one strain relief strip, is embodied as an extruded sheath. In other words, the at least one strain relief strip is produced during the production of the insulating sheath by means of extrusion therewith. The strain relief strip is therefore embodied as an extruded strip in a simple manner during the extrusion of the insulating sheath.

In a preferred embodiment, the core sheath region and the at least one strain relief strip are formed by means of a co-extrusion process. As a consequence, the entire insulating sheath can be extruded onto the electrical conductor core in only one working step. A so-called co-extruder is used in order to form the at least one strain relief strip or multiple strain relief strips. The still plastic masses for the core sheath region and the strain relief strips are directed to a common extrusion head.

In an expedient embodiment, the at least one strain relief strip is recessed on the edge side in the core sheath region and defines an arc-shaped segment, in particular a circular arc of a preferably circular peripheral contour of the insulating sheath. The term ‘recessed’ is to be understood in this case to mean that the core sheath region comprises an edge-side recess in which the strain relief strip is received in a custom-fit manner. By virtue of the common extrusion process, in which the two plastic masses are guided through a common extrusion head, the extrusion head therefore defines the common contours that are formed by means of the two plastic masses.

In particular, the at least one strain relief strip—when viewed in the cross-section—is embodied in a lens-shaped manner, in other words has a cross-section geometric shape that is comparable to a converging lens having two convexly curved surfaces. The forces that occur during the common extrusion process cause the strain relief strip to assume such a form that is therefore characteristic for the common extrusion process.

Irrespective of the number of strain relief strips used, the insulating sheath is ii further embodied in such a manner that a matrix of fiber composite material is material-bonded to the core sheath region. In particular, materials are selected for this material-bonded connection that are suitable for the matrix and also for the core sheath region so that this produces a particularly non-detachable material-bonded connection during the extrusion process.

Accordingly, in a preferred further development, the core sheath region and the matrix of the fiber composite material are also produced from the identical material, by way of example from a PVC material. The fibers that are preferably embodied as short fibers are embedded in the matrix. The short fibers have in an expedient manner a length in the range of a maximum few millimeters, preferably a maximum 10 mm and in particular a maximum 2 mm. The diameter of the fibers is typically in the range of a few 1 μm to a few 100 μm. Short fibers of this type are easy to process with regards to production technology.

In an expedient manner, the insulating sheath is produced for the at least one strain relief strip by means of an extrusion process using a synthetic material mass in which the short fibers are already provided prior to the extrusion process. The extrusion process automatically arranges the fibers in an expedient embodiment in a preferred direction in the longitudinal direction of the cable. This automatic orientation at least of a large portion of the fibers has a positive influence on the tensile strength in the longitudinal direction of the cable.

It is preferred that the portion of fibers is in the region of 0.5 vol. % up to a maximum 20 vol. %, preferably up to a maximum for instance 10 vol. % with regard to the total volume of the insulating material. This renders it possible to achieve a good tensile strength whilst maintaining good insulating characteristics.

It is preferred that glass fibers that have a diameter in the pm range are used as the fiber material. In addition, it is also possible to provide other fibers, such as by way of example polymer fibers, cellulose fibers, carbon fibers etc. ii When using glass fibers, their portion is by way of example preferably in a range of approx. 0.5 to 20 vol. %.

Furthermore, in an expedient manner, the at least one strain relief strip extends in the longitudinal direction over the entire extent of the electrical conductor core. The electrical cable is in particular a so-called yard goods that has the at least one strain relief strip extending through it and consequently can be cut to any length.

Furthermore, the cable is preferably embodied as a so-called sheath cable in accordance with DIN 72551 (part 5 and 6) or ISO 6722 (Class A and B) and/or designed for a current less than 1 A and preferably as a signal cable for a signal current less than 0.5 A. The nominal cross-section of the conductor core that can also be embodied as a simple conductor preferably amounts to a maximum 2 mm² and is preferably below 1 mm². In the event that this is used for signal cables and copper is used for the conductor material, the nominal cross-section is preferably in the range of below 0.35 mm².

Furthermore, it is preferred that the outer diameter of the cable is a maximum 1 to 4.5 mm and is preferably a maximum 1 to 3.5 mm. It is preferred that the wall thickness of the insulating sheath is in the range typically up to a maximum 1.5 mm and preferably is only 0.5 to 0.7 mm and a synthetic material, in particular a PVC, PP or PS, is used as the material for the matrix and/or the core sheath region.

Furthermore, it is preferred that the radial extension of the at least one strain relief strip in a transverse manner with respect to the longitudinal direction and in the radial direction of the electrical cable corresponds to between 20% and 60% of the smallest wall thickness of the insulating material when viewed over the circumference of the insulating sheath.

Furthermore, the total of all the applied strain relief strips covers in the peripheral direction preferably a smaller angular region than the total of the part regions of the core sheath region between the strain relief strip. In particular, the total of the strain relief strips covers an angular region of a maximum 180°, in particular a maximum 90°.

In addition, it is preferred that the cross-sectional area that is covered by the strain relief strips amounts to only 10% to 40% of the entire cross-sectional area of the insulating sheath.

Furthermore, it is preferred that the at least one strain relief strip and preferably all strain relief strips in the electrical cable extend essentially parallel and in a straight line with respect to the electrical conductor core. As an alternative thereto, the at least one strain relief strip is quasi wound around the electrical conductor core and encompasses it in a helical manner.

The relative position of the at least one strain relief strip is indicated in an expedient manner by means of a colored marking on the outer face of the insulating sheath.

Overall, it is of advantage if the insulating sheath comprises multiple strain relief strips that extend in the longitudinal direction of the electrical conductor and that typically any occurring tensile load is then distributed over said strain relief strips. It is possible in this manner to design the cable for higher tensile loads and/or it is possible to reduce the nominal cross-section of a respective corresponding strain relief strip.

In an advantageous further development, the strain relief strips are arranged—when viewed in the cross-section—evenly distributed over the circumference of the electrical conductor core.

In addition, the concept introduced here can be expanded in order to impart a corresponding electrical cable or at least its insulating material with further characteristics, by way of example in that the fiber composite material is provided with different fibers, wherein the fibers differ in particular with respect to the fiber material.

It is preferred that the fiber composite material comprises conductive, in particular metal, fibers or particles for forming a shielding arrangement, in particular such as is described by way of example in DE 201 21 335 U1. This produces a shielding effect in particular in the case of low-cost applications where a shielding arrangement is not usual. As an alternative, a classic shielding arrangement, for example a wire mesh or a film shield, is replaced by this shielding effect. It is preferred that an additional shielding layer for the insulating sheath is not provided.

These metal fibers or particles are provided in the fiber composite material in addition to the non-metal fibers. The portion of the metal fibers or particles is—depending upon the desired application—optionally greater than, equal to or less than the portion of the non-metal fibers.

However, the use of metal fibers or particles is not limited to embodiments in which the fiber composite material comprises different fibers. As an alternative, the fiber composite material comprises embedded therein and depending upon the respective design variant solely metal fibers and/or corresponding metal fibers are embedded in the core sheath region. In the latter case, the metal fibers are arranged in a radial part region and/or only in a small concentration so that the fundamentally insulating character of the insulating sheath remains intact.

As already previously mentioned, it is preferred that an electrical cable that is proposed in this case is embodied and designed as a signal cable and in particular as a data transmission cable for transmitting data signals in the high frequency range, by way of example in the megahertz range or gigahertz range. The corresponding data transmission cables are provided in particular for the automotive industry and are based for example on the so-called Ethernet technology. They are described as Ethernet cables and comprise a number of wire pairs that are grouped together in one data cable and are encompassed by a common insulating sheath. If an electrical cable that is proposed in this case is embodied as such a data transmission cable, then the electrical conductor core is provided by means of a corresponding number of wire pairs, wherein depending upon the design variant each wire pair comprises a dedicated shielding arrangement that shields the corresponding wire pair from the other wire pairs provided. In addition, the wire pairs are preferably twisted.

Exemplary embodiments of the invention are further explained hereinunder with reference to a schematic drawing. In the drawing:

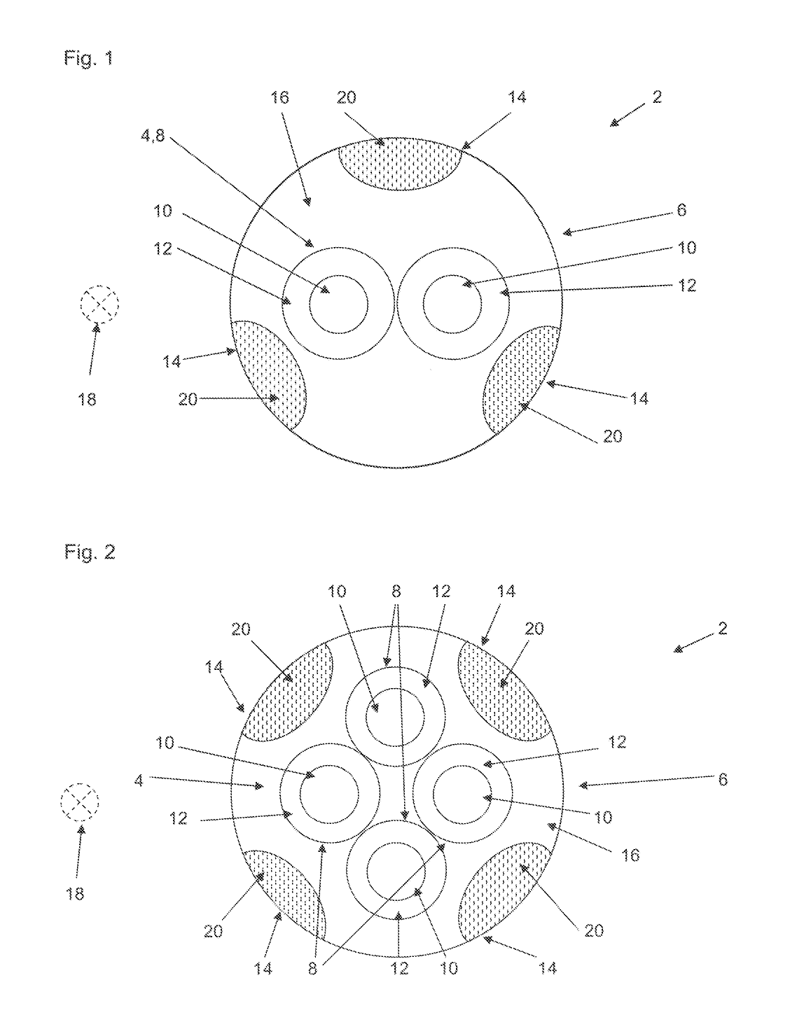

FIG. 1 illustrates a cross-sectional view of a data transmission cable and

FIG. 2 illustrates a cross-sectional view of an alternative embodiment of the data transmission cable.

Mutually corresponding parts are provided in all the figures in each case with like reference numerals.

A data transmission cable 2 that is described by way of example hereinunder and is illustrated in FIG. 1 is preferably provided for use in a motor vehicle, which is not further illustrated, and is installed in such a motor vehicle. It is used in this case in an on-board electrical system as an electrical cable for signal transmission and is preferably embodied as a so-called sheath cable in accordance with DIN 72551 (Part 5 and 6) or ISO 6722 (Class A and B). It generally encompasses an electrical conductor core 4 that is directly encased by an insulating sheath 6, in particular is embedded therein. The insulating sheath 6 forms in particular an outer sheath.

The electrical conductor core 4, or in short ‘conductor core 4’ is generally formed by means of multiple conductors 10 that are typically encompassed in each case by a conductor sheath 12. The conductors 10 and the conductor sheath 12 form in each case an insulated wire. Two such wires frequently form a wire pair 8 that is used to transmit an in particular digital data signal, especially a symmetrical data signal. In the case of the symmetrical data transmission, one signal is transmitted by way of a wire and the corresponding inverted signal is transmitted by the other wire.

The wires are twisted in particular in pairs with respect to one another as required and thus form twisted wire pairs 8. As an alternative, spiral fours, by way of example a star quad cable, can also be embodied. In this case, two opposite-lying wires form in each case one wire pair 8 that is used for the symmetrical data transmission.

In the exemplary embodiment in accordance with FIG. 1, the conductor core 4 is formed by means of precisely one in particular twisted wire pair 8.

The insulating sheath 6 of the data transmission cable 2 comprises further three strain relief strips 14 that are arranged—when viewed in the cross-section—evenly distributed over the circumference of the insulating sheath 6. The strain relief strips 14 are arranged in the outer-side depressions in a core sheath region 16 and are recessed therein so that the core sheath region 16 and the strain relief strips 14 together form an insulating sheath 6 that has a smooth, circular cross section.

The strain relief strips 14 themselves all comprise in this exemplary embodiment the identical geometric shape. They have a lens-shaped cross-section, wherein the corresponding bi-convex lens shape is formed by means of two arcs that have different radii and contact one another at the end. Those strain relief strips 14 extend quasi in a strip-shaped manner in the longitudinal direction 18 of the data transmission cable 2 and in so doing extend over the entire extension of the data transmission cable 2 in the longitudinal direction 18.

In general, the core sheath region 16 is embodied from a suitable extrudable insulating material, by way of example a thermoplastic elastomer (TPE), but it is not limited thereto.

The strain relief strips 14 in turn are embodied from a matrix of an insulating ii material in which fibers 20 are embedded, said fibers being embodied from an inert, non-conductive material and especially from glass fibers 20. It is preferred that the matrix is embodied, as in the exemplary embodiment, from the identical material as the core sheath region 16, wherein however different colorants are mixed together in order to achieve in this manner by way of example colored markings.

The insulating sheath 6 of the data transmission cable 2 is furthermore produced within the scope of a single production process step and applied to or extruded on the electrical conductor core 4 by means of the extrusion process. A so-called co-extrusion method is used, wherein two different material melts or synthetic material melts are guided together prior to exiting or as they exit a profiling nozzle or an extrusion head. The synthetic material melt for the strain relief strips 14 already comprises the glass fibers 20 and is preferably supplied by way of a so-called co-extruder. Moreover, it is preferred to forego the use of a bonding agent in the case of this process.

An alternative embodiment of the data transmission cable 2 is illustrated in FIG. 2, wherein the data transmission cable 2 comprises a conductor core 4 having two wire pairs 8 and wherein four strain relief strips 14 supplement the core sheath region 16.

The invention is not limited to the above described exemplary embodiment. On the contrary, other variants of the invention can also be derived by a person skilled in the art without departing from the subject of the invention. In particular, all individual features that are described in connection with the exemplary embodiment can moreover also be combined with one another without departing from the subject of the invention.

### LIST OF REFERENCE NUMERALS

2 Data transmission cable
4 Conductor core
6 Insulating sheath
8 Wire pair
10 Conductor
12 Conductor sheath
14 Strain relief strip
16 Core sheath region
18 Longitudinal direction
20 Glass fiber

1-14. (canceled)

15. An electrical cable, comprising:
an electrical conductor core;
an extruded insulating sheath encompassing said electrical conductor core;
said extruded insulating sheath including a core sheath region and at least one strain relief strip formed of a fiber composite material and extending in a longitudinal direction of the electrical conductor core.

16. The electrical cable according to claim 15, wherein said core sheath region and said at least one strain relief strip have the common characteristics of having been formed together in a co-extrusion process.

17. The electrical cable according to claim 16, wherein said insulating sheath has a circular peripheral contour and said at least one strain relief strip is recessed on an edge side in said core sheath region, with said strain relief strip forming an arc segment of said insulating sheath.

18. The electrical cable according to claim 17, wherein said strain relief strip forms a circular arc segment of said insulating sheath.

19. The electrical cable according to claim 15, wherein said at least one strain relief strip has a lens-shaped cross-section.

20. The electrical cable according to claim 15, wherein a matrix of said fiber composite material is welded to said core sheath region.

21. The electrical cable according to claim 20, wherein said core sheath region and the matrix of said fiber composite material are produced of identical material.

22. The electrical cable according to claim 15, wherein said at least one strain relief strip extends in the longitudinal direction over an entire extent of said electrical conductor core.

23. The electrical cable according to claim 15, wherein said at least one strain relief strip is one of a plurality of strain relief strips extending in the longitudinal direction of said electrical conductor core.

24. The electrical cable according to claim 23, wherein said strain relief strips, as viewed in cross section of the electrical cable, are arranged evenly distributed about a circumference of said electrical conductor core.

25. The electrical cable according to claim 15, which comprises conductive fibers embedded in said insulating sheath forming a shielding arrangement.

26. The electrical cable according to claim 25, wherein said conductive fibers are metal fibers.

27. The electrical cable according to claim 15, wherein said insulating sheath comprises conductive fibers forming a shielding arrangement, and said fibers are embedded in said fiber composite material and/or in said core sheath region.

28. The electrical cable according to claim 27, wherein said conductive fibers are metal fibers.

29. The electrical cable according to claim 15, wherein the electrical cable is a data transmission cable, wherein said electrical conductor core comprises a plurality of wire pairs.

30. The electrical cable according to claim 15, wherein said wire pairs are twisted wire pairs.

31. The electrical cable according to claim 15, wherein the electrical cable is a signal cable configured for signal current of less than 0.5 amperes and wherein said extruded insulating sheath encompasses said conductor core directly and said strain relief strip and said core sheath region are formed in a co-extrusion process.

32. A method for producing an electrical cable, the method comprises:
providing an electrical conductor core; and
forming an insulating sheath to directly encompass the electrical conductor core, and thereby extruding a core sheath region of the insulating sheath and at least one strain relief strip from a fiber composite material onto the conductor core.
